(19) United States
(12) Patent Application Publication
(10) Pub. No.: US 2023/0084251 A1
(43) Pub. Date: Mar. 16, 2023

(54) HEAT SEALING AQUEOUS RESIN COMPOSITION, FILM, LAMINATE, AND METHOD FOR PRODUCING SAME

(71) Applicant: ARAKAWA CHEMICAL INDUSTRIES, LTD., Osaka (JP)

(72) Inventors: Keisuke Okada, Osaka (JP); Kaito Kuroda, Osaka (JP); MAYU MATSUMOTO, Osaka (JP); Teruaki Sato, Osaka (JP)

(73) Assignee: ARAKAWA CHEMICAL INDUSTRIES, LTD., OSAKA (JP)

(21) Appl. No.: 17/894,163

(22) Filed: Aug. 24, 2022

(30) Foreign Application Priority Data
Sep. 2, 2021 (JP) 2021-142845

(51) Int. Cl. C08L 67/02; C08L 67/04; C08J 5/18; C08J 3/05; C08J 3/00

(52) U.S. Cl. CPC C08L 67/02; C08L 67/04; C08J 5/18; C08J 3/05; C08J 3/005; C08L 2205/035; C08L 2205/025; C08L 2201/06; C08L 2203/162; C08J 2367/02; C08J 2367/04; C08J 2493/04; C08J 2429/04

(57) ABSTRACT

The present disclosure provides a heat sealing aqueous resin composition containing: a rosin resin (A); a biodegradable resin (B) including a resin having a structure of General Formula (1) and/or a resin (b1) having a structure of General Formula (2); and a polyvinyl alcohol (C) in which an average saponification degree is 75 mol % or more and 85 mol % or less, in which a content of the component (b1) is more than 50% by mass when a total content of the component (A) and the component (B) is 100% by mass.

—O—(CH₂)ₓ—O—CO—(CH₂)_{y}—CO— General Formula (1):
(in General Formula (1), x and y may be different from each other, and are integers of 1 or more and 10 or less)

—O—(CH₂)_{z}—CO— General Formula (2):
(in General Formula (2), z is an integer of 3 or more and 10 or less)

### CROSS-REFERENCE TO RELATED APPLICATIONS

This application claims the priority benefit of Japanese Patent Application No. 2021-142845, filed on Sep. 2, 2021. The entirety of the above-mentioned patent application is hereby incorporated by reference herein and made a part of this specification.

### BACKGROUND

### Technical Field

The present disclosure relates to a heat sealing aqueous resin composition, a film thereof, and a laminate thereof, and a method for producing the same.

### Description of Related Art

It is known to use a heat sealing resin composition containing a polyolefin resin as a heat sealing resin composition for adhering a packaging material for encompassing foods, beverages, pharmaceuticals, clothing, miscellaneous goods, daily necessities, and the like. For example, Patent Document 1 discloses a heat sealing resin composition in which a metallocene-based α-olefin-copolymerized polyethylene was used.

### PATENT DOCUMENTS

Patent Document 1: Japanese Patent Laid-Open No. H11-198287

### SUMMARY

The conventional heat sealing resin composition contains a large amount of persistent plastics (polyolefin resin and the like). Because it has been pointed out that these persistent plastics cause soil and water pollution due to improper disposal, for example, it is required to use a component reducing the burden on the environment.

Meanwhile, a heat sealing resin composition containing a biodegradable resin is also known. For such a heat sealing resin composition, as a production method thereof, at least one of a method of emulsifying by applying a strong pressure of more than 1 MPa, or a method of emulsifying by dispersing a biodegradable resin and the like in various solvents, and thereafter desolvating is often used. Because the former method consumes a large amount of energy, and the latter method uses a solvent, there are problems that energy is required for the desolvating process, and that there is quite an impact on the environment due to the solvent used.

Furthermore, energy saving when performing heat sealing is also required, and a resin composition having a property of favorable heat sealing at low temperature (also referred to as “low-temperature heat sealability” in the present disclosure) is required.

The present disclosure provides a heat sealing aqueous resin composition, a film thereof, and a laminate thereof, which exhibit favorable low-temperature heat sealability, and a method for producing the same while adopting a production method and a composition reducing the impact on the environment.

As a result of diligent studies, the inventors of the present invention found that the above-mentioned aspects can be achieved by a predetermined heat sealing aqueous resin composition, a film thereof, and a laminate thereof, and a method for producing the same. The present disclosure is to provide at least a part of the above-mentioned aspects, and can be embodied as the following aspects or application examples.

The present disclosure provides the following aspects.

Aspect 1

A heat sealing aqueous resin composition containing: a rosin resin (A); a biodegradable resin (B) including a resin having a structure of General Formula (1) and/or a resin (b1) having a structure of General Formula (2); and a polyvinyl alcohol (C) in which an average saponification degree is 75 mol % or more and 85 mol % or less, in which a content of the component (b1) is more than 50% by mass when a total content of the component (A) and the component (B) is 100% by mass.

—O—(CH₂)ₓ—O—CO—(CH₂)_{y}—CO— General Formula (1):

(in General Formula (1), x and y may be different from each other, and are integers of 1 or more and 10 or less)

—O—(CH₂)_{z}—CO— General Formula (2):

(in General Formula (2), z is an integer of 3 or more and 10 or less)

Aspect 2

The heat sealing aqueous resin composition according to aspect 1, further containing one or more compounds (D) selected from the group consisting of monosaccharides, disaccharides, sugar alcohols, organic acids, amino acids, and ureas.

Aspect 3

A film of the heat sealing aqueous resin composition according to aspect 1 or 2.

Aspect 4

A laminate including: the film according to aspect 3; and a substrate.

Aspect 5

A method for producing a heat sealing aqueous resin composition, the method including inversion-emulsifying a mixture of a component (A) and a component (B) without a solvent and under a normal pressure or a pressure of 1 MPa or less.

Since a large amount of biodegradable materials are used in the heat sealing aqueous resin composition and the film thereof provided in the present disclosure, the burden on the environment is reduced. In addition, the method for producing a heat sealing aqueous resin composition provided in the present disclosure employs a method that reduces the impact on the environment. Furthermore, since the heat sealing aqueous resin composition, the film, and the laminate provided in the present disclosure can exhibit favorable low-temperature heat sealability, they also contribute to energy saving and are able to seal in a short time, thereby significantly improving production efficiency.

### DESCRIPTION OF THE EMBODIMENTS

Throughout the present disclosure, the range of numerical values such as each physical property value and content can be appropriately set (for example, by selecting from the upper limit and lower limit values described in each of the following items). Specifically, regarding a numerical value a, when examples of the lower limit of the numerical value a include A1, A2, A3, and the like, and examples of the upper limit of the numerical value a include B1, B2, B3, and the like, examples of the range of the numerical value a include A1 or more, A2 or more, A3 or more, B1 or less, B2 or less, B3 or less, A1 to B1, A1 to B2, A1 to B3, A2 to B1, A2 to B2, A2 to B3, A3 to B1, A3 to B2, and A3 to B3. In the present disclosure, “to” is used in the sense that the numerical values described before and after it are included as the lower limit value and the upper limit value.

Component (A)

As a rosin resin (A) (also referred to as a “component (A)” in the present disclosure), various known rosins can be used. Examples of the component (A) include unmodified rosin, hydrogenated rosin, disproportionated rosin, polymerized rosin, α,β-unsaturated carboxylic acid-modified rosin, or esterified products thereof, and rosin phenolic resin. Examples of the esterified product include unmodified rosin esters, hydrogenated rosin esters, disproportionated rosin esters, polymerized rosin esters, and α,β-unsaturated carboxylic acid-modified rosin esters.

Examples of the unmodified rosin include natural rosin and purified rosin. Examples of the natural rosin include natural rosin (gum rosin, tall oil rosin, wood rosin) derived from horsetail pine, slash pine, Merkus pine, Khasi pine, Pinus elliottii, Pinus taeda, longleaf pine, or the like. Examples of the purified rosin include those obtained by purifying natural rosin by a reduced-pressure distillation method, a steam distillation method, an extraction method, a recrystallization method, or the like. The unmodified rosin esters are obtained by reacting the above-mentioned unmodified rosin with alcohols. Examples of the alcohols include monohydric alcohols, and polyhydric alcohols (dihydric alcohols, trihydric alcohols, tetrahydric alcohols, hexahydric alcohols, and the like). Examples of the monohydric alcohols include methanol, ethanol, propanol, and stearyl alcohol. Examples of the dihydric alcohols include ethylene glycol, diethylene glycol, triethylene glycol, propylene glycol, neopentyl glycol, and dimerdiol. Examples of the trihydric alcohols include glycerin, trimethylolethane, and trimethylolpropane. Examples of the tetrahydric alcohols include pentaerythritol and diglycerin. Examples of the hexahydric alcohols include dipentaerythritol. The alcohols are preferably polyhydric alcohols, and more preferably diethylene glycol, glycerin, and pentaerythritol. Regarding the reaction between the unmodified rosin and the alcohols, a method of reacting the unmodified rosin and the alcohols at about 250° C. to 280° C. for about 1 to 8 hours in the presence or absence of a solvent by adding an esterification catalyst as necessary may be exemplified.

The hydrogenated rosin is obtained by a hydrogenation reaction of unmodified rosin. Various known methods are exemplified as a method of obtaining the hydrogenated rosin. Specifically, a method of heating the unmodified rosin at a hydrogen pressure of about 2 to 20 MPa (preferably about 5 to 20 MPa) and 100° C. to 300° C. (preferably about 150° C. to 300° C.) in the presence of a hydrogenation catalyst may be exemplified. Examples of the hydrogenation catalyst include supported catalysts and metal powders. Examples of the supported catalysts include palladium on carbon, rhodium on carbon, ruthenium on carbon, and platinum on carbon. Examples of the metal powders include nickel and platinum. The hydrogenation catalyst is preferably a palladium, rhodium, ruthenium, or platinum catalyst from the viewpoint of increasing the hydrogenation rate of the unmodified rosin and shortening the hydrogenation time. The use amount of the hydrogenation catalyst is usually about 0.01 to 5 parts by mass and preferably about 0.01 to 2 parts by mass with respect to 100 parts by mass of the unmodified rosin. The hydrogenated rosin esters are obtained by reacting the hydrogenated rosin with the alcohols. The reaction between the hydrogenated rosin and the alcohols may be carried out at about 250° C. to 280° C. for about 1 to 8 hours in the presence or absence of a solvent by adding an esterification catalyst as necessary. Regarding the order of the hydrogenation reaction and the esterification reaction, the hydrogenation reaction may be carried out after the esterification reaction, or the esterification reaction may be carried out after the hydrogenation reaction.

The disproportionated rosin is obtained by a disproportionation reaction of the unmodified rosin. Various known methods are exemplified as a method of obtaining the disproportionated rosin. Specifically, a method of heating and reacting the unmodified rosin in the presence of a disproportionation catalyst may be exemplified. Examples of the disproportionation catalyst include supported catalysts, metal powders, and iodized products. Examples of the supported catalysts include palladium on carbon, rhodium on carbon, and platinum on carbon. Examples of the metal powders include nickel and platinum. Examples of the iodized products include iodine and iron iodide. The use amount of the disproportionation catalyst is usually about 0.01 to 5 parts by mass and preferably about 0.01 to 1 part by mass with respect to 100 parts by mass of the rosin as a raw material. The reaction temperature at the time of the disproportionation reaction is usually about 100° C. to 300° C., and preferably about 150° C. to 290° C. The disproportionated rosin esters are obtained by further reacting the disproportionated rosin with the alcohols to esterify it. The reaction between the disproportionated rosin and the alcohols may be carried out at about 250° C. to 280° C. for about 1 to 8 hours in the presence or absence of a solvent by adding an esterification catalyst as necessary. Regarding the order of the disproportionation reaction and the esterification reaction, the disproportionation reaction may be carried out after the esterification reaction, or the esterification reaction may be carried out after the disproportionation reaction.

The polymerized rosin is obtained by polymerizing the unmodified rosin. The polymerized rosin is a rosin derivative containing a dimerized resin acid. Various known methods are exemplified as a method of obtaining the polymerized rosin. Specifically, a method of reacting the unmodified rosin in a solvent (toluene, xylene, or the like) containing a catalyst (sulfuric acid, hydrogen fluoride, aluminum chloride, titanium tetrachloride, or the like) at the reaction temperature of about 40° C. to 160° C. for 1 to 5 hours may be exemplified. The polymerized rosin esters are obtained by reacting the polymerized rosin with the alcohols. The reaction between the polymerized rosin and the alcohols may be carried out at about 250° C. to 280° C. for about 1 to 8 hours in the presence or absence of a solvent by adding an esterification catalyst as necessary. The polymerized rosin may be further modified (hydrogenation, disproportionation, α,β-unsaturated carboxylic acid modification (acrylating, maleating, fumarating, or the like) or the like). Regarding the order of the polymerization reaction and the esterification reaction, the polymerization reaction may be carried out after the esterification reaction, or the esterification reaction may be carried out after the polymerization reaction.

Examples of the α,β-unsaturated carboxylic acid-modified rosin include acrylated rosin, maleated rosin, and fumarated rosin. Various known methods are exemplified as a method of obtaining the α,β-unsaturated carboxylic acid-modified rosin. Specifically, a method of causing the addition reaction of an α,β-unsaturated carboxylic acid with the unmodified rosin or the disproportionated rosin may be exemplified. Examples of the α,β-unsaturated carboxylic acid include acrylic acid, methacrylic acid, maleic acid, fumaric acid, itaconic acid, citraconic acid, muconic acid, maleic acid anhydride, itaconic acid anhydride, citraconic acid anhydride, and muconic acid anhydride. The α,β-unsaturated carboxylic acid is preferably maleic acid, maleic acid anhydride, or fumaric acid. The use amount of the α,β-unsaturated carboxylic acid is usually about 1 to 20 parts by mass and preferably about 1 to 3 parts by mass with respect to 100 parts by mass of the unmodified rosin or the disproportionated rosin from the viewpoint of emulsifiability. As a method for producing the α,β-unsaturated carboxylic acid-modified rosin, a method of adding α,β-unsaturated carboxylic acid to the unmodified rosin or disproportionated rosin which has been melted under heating to cause a reaction at the temperature of about 180° C. to 240° C. for about 1 to 9 hours may be exemplified. The reaction may be carried out while blowing an inert gas (nitrogen or the like) into the closed reaction system. In the reaction, a Lewis acid catalyst (zinc chloride, iron chloride, tin chloride, or the like), or a Bronsted acid catalyst (Bronsted acid such as para-toluenesulfonic acid and methanesulfonic acid) may be used. The use amount of the catalyst is usually about 0.01% to 10% by mass with respect to the unmodified rosin or the disproportionated rosin. The α,β-unsaturated carboxylic acid-modified rosin esters are obtained by reacting the α,β-unsaturated carboxylic acid-modified rosin with the alcohols. The obtained α,β-unsaturated carboxylic acid-modified rosin may contain a resin acid derived from the unmodified rosin or the disproportionated rosin, where the content thereof is usually less than 10% by mass. As the reaction between the α,β-unsaturated carboxylic acid-modified rosin and the alcohols, a method of adding the alcohols to the α,β-unsaturated carboxylic acid-modified rosin which has been melted under heating to cause a reaction at the temperature of about 250° C. to 280° C. for about 15 to 20 hours may be exemplified. The reaction may be carried out while blowing an inert gas (nitrogen or the like) into the closed reaction system. The Lewis acid catalyst or the Bronsted acid catalyst may be used in the reaction.

The component (A) contains an esterified product of the rosin resin, thereby tending to have excellent heat sealability. When the component (A) is 100% by mass (in terms of solid contents), examples of the upper limit of the content (% by mass, in terms of solid contents) of the esterified product of the rosin resin include 100, 99, 95, 90, 80, 70, 60, 50, 40, 30, 20, 10, and 5, and examples of the lower limit thereof include 99, 95, 90, 80, 70, 60, 50, 40, 30, 20, 10, 5, and 1. In one embodiment, the content of the esterified product of the rosin resin (% by mass, in terms of solid contents) when the component (A) is 100% by mass (in terms of solid contents) is preferably about 1 to 100.

Examples of the upper limit of the softening point (° C.) of the component (A) include 200, 190, 180, 170, 160, 150, 140, 130, 120, 110, 100, 90, 80, 70, and 60, and examples of the lower limit thereof include 190, 180, 170, 160, 150, 140, 130, 120, 110, 100, 90, 80, 70, 60, and 50. In one embodiment, the softening point (° C.) of the component (A) is preferably about 50 to 150. In the present disclosure, the softening point is a value measured by a ring-and-ball method (JIS K 5902).

Examples of the upper limit of the acid value (mg KOH/g) of the component (A) include 300, 280, 260, 240, 220, 200, 180, 160, 140, 120, 100, 80, 60, 40, 20, 10, 1, and 0.5, and examples of the lower limit thereof include 280, 260, 240, 220, 200, 180, 160, 140, 120, 100, 80, 60, 40, 20, 10, 1, 0.5, and 0.1. In one embodiment, the acid value (mg KOH/g) of the component (A) is preferably about 300 or less. In the present disclosure, the acid value is a value measured by JIS K 0070.

Examples of the upper limit of the weight-average molecular weight of the component (A) include 5,000, 4,000, 3,000, 2,000, 1,000, 500, 400, 300, and 200, and examples of the lower limit thereof include 4,000, 3,000, 2,000, 1,000, 500, 400, 300, 200, and 100. In the present disclosure, the weight-average molecular weight is a value expressed in terms of polystyrene obtained by a gel permeation chromatography (GPC) method.

Examples of the upper limit of the number of colors (Gardner) of the component (A) include 10, 8, 6, 4, and 2, and examples of the lower limit thereof include 8, 6, 4, 2, and 1. In one embodiment, the number of colors (Gardner) of the component (A) is preferably about 10 or less. Examples of the upper limit of the number of colors (Hazen) of the component (A) include 200, 175, 150, 125, 100, 80, and 60, and examples of the lower limit thereof include 175, 150, 125, 100, 80, 60, and 40. In one embodiment, the number of colors (Hazen) of the component (A) is preferably about 200 or less. In the present disclosure, the number of colors is measured in Gardner units and Hazen units according to JIS K 0071-1 and JIS K 0071-2.

Examples of the upper limit of the content (% by mass, in terms of solid contents) of the component (A) with respect to 100% by mass of the component (A), a component (B), and a component (C) of the present disclosure in terms of solid contents include 50, 45, 40, 35, 30, 25, 20, 15, 10, 5, and 3, and examples of the lower limit thereof include 45, 40, 35, 30, 25, 20, 15, 10, 5, 3, and 1. In one embodiment, the content of the component (A) (% by mass, in terms of solid contents) with respect to 100% by mass of the component (A), the component (B), and the component (C) of the present disclosure in terms of solid contents is preferable about 1 to 50.

Component (B)

Various known resins can be used as a biodegradable resin (B) (also referred to as “component (B)” in the present disclosure) including a resin having the structure of General Formula (1) and/or a resin (b1) having the structure of General Formula (2) (also referred to as “component (b1)” in the present disclosure). In the present disclosure, the biodegradable resin as the component (B) does not include the component (C). Furthermore, the structures of a plurality General Formulas (1) may be present in the resin having the structure of General Formula (1), where x's and y's of each of General Formulas (1) may be different from each other, respectively. Furthermore, the structures of a plurality General Formulas (2) may be present in the resin having the structure of General Formula (2), where z's of each of General Formulas (2) may be different from each other, respectively.

—O—(CH₂)ₓ—O—CO—(CH₂)_{y}—CO— General Formula (1):

(in General Formula (1), x and y may be different from each other, and are integers of 1 or more and 10 or less)

Examples of the upper limit of each of x's and y's of General Formulas (1) include 10, 9, 8, 7, 6, 5, 4, 3, and 2, and examples of the lower limit thereof include 9, 8, 7, 6, 5, 4, 3, and 2. In one embodiment, each of x's and y's of General Formulas (1) is preferably 1 to 10.

Examples of the resin having the structure of General Formula (1) include polybutylene succinate (PBS), polybutylene succinate adipate (PBSA), polybutylene succinate lactate (PBSL), polybutylene adipate terephthalate (PBAT), and polyethylene succinate (PES).

—O—(CH₂)_{z}—CO— General Formula (2):

(in General Formula (2), z is an integer of 3 or more and 10 or less)

Examples of the upper limit of each of z's of General Formulas (2) include 10, 9, 8, 7, 6, 5, and 4, and examples of the lower limit thereof include 9, 8, 7, 6, 5, 4, and 3. In one embodiment, each of z's of General Formulas (2) is preferably 3 to 10.

Examples of the resin having the structure of General Formula (2) include polycaprolactone.

The component (B) may include a biodegradable resin (b2) (also referred to as “component (b2)” in the present disclosure) other than the component (b1). Examples of the component (b2) include a biodegradable resin having a polyester structure, and a biodegradable resin having a sugar-derived structure.

Examples of the biodegradable resin having a polyester structure include polyhydroxybutyrate, polyglycolic acid, and polylactic acid. It is preferable that the heat sealing aqueous resin composition of the present disclosure do not contain polylactic acid as much as possible because when polylactic acid is contained in the heat sealing aqueous resin composition of the present disclosure, the production method of the present disclosure tends to cause the state in which the resin component and water are less likely to be mixed with other (separation from water).

Examples of the biodegradable resin having a sugar-derived structure include starch, cellulose, chitosan, esterified starch, and cellulose acetate.

Examples of the upper limit of the weight-average molecular weight of the component (B) include 300,000, 200,000, 100,000, 90,000, 80,000, 70,000, 60,000, 50,000, 40,000, 30,000, 20,000, 10,000, 9,000, 8,000, 7,000, and 6,000, and example of the lower limit thereof include 200,000, 100,000, 90,000, 80,000, 70,000, 60,000, 50,000, 40,000, 30,000, 20,000, 10,000, 9,000, 8,000, 7,000, 6,000, and 5,000. In one embodiment, the weight-average molecular weight of the component (B) is preferably about 5,000 to 300,000. In the present disclosure, the weight-average molecular weight is a value expressed in terms of polystyrene obtained by a gel permeation chromatography method. The higher the weight-average molecular weight of the component (B), the better the low-temperature heat sealability tends to be. Furthermore, the lower the weight-average molecular weight of the component (B), the better the emulsification tends to be, or the better the fluidity at the time of sealing tends to be. Therefore, the weight-average molecular weight of the component (B) is preferably in the above-mentioned range.

Examples of the upper limit of the molecular weight distribution (Mw/Mn) of the component (B) include 10, 9, 7.5, 5, 2.5, and 2, and examples of the lower limit thereof include 9, 7.5, 5, 2.5. 2, and 1.5. In one embodiment, the molecular weight distribution (Mw/Mn) of the component (B) is preferably 1.5 to 10.

Examples of the upper limit of the melting point (° C.) of the component (B) include 200, 190, 180, 170, 160, 150, 140, 130, 120, 110, 100, 90, 80, 70, 60, 50, and 40, and examples of the lower limit thereof include 190, 180, 170, 160, 150, 140, 130, 120, 110, 100, 90, 80, 70, 60, 50, 40, and 30. In one embodiment, the melting point (° C.) of the component (B) is preferably about 30 to 200. In the present disclosure, the melting point is a value measured by a method relating to the melting temperature described in JIS K 7121.

Examples of the upper limit of the glass transition temperature (° C.) of the component (B) include 100, 90, 80, 70, 60, 50, 40, 30, 20, 10, 0, −10, −20, −30, −40, −50, −60, −70, −80, and −90, and examples of the lower limit thereof include 90, 80, 70, 60, 50, 40, 30, 20, 10, 0, −10, —20, −30, −40, −50, −60, −70, −80, −90, and −100. In one embodiment, the glass transition temperature (° C.) of the component (B) is preferably about −100 to 100. In the present disclosure, the glass transition temperature (° C.) is a value measured by a method described in JIS K 7121.

Examples of the upper limit of the crystallization temperature (° C.) of the component (B) include 100, 90, 80, 70, 60, 50, 40, 30, 20, 10, 0, −10, −20, −30, −40, −50, −60, −70, −80, and −90, and examples of the lower limit thereof include 90, 80, 70, 60, 50, 40, 30, 20, 10, 0, −10, —20, −30, −40, −50, −60, −70, −80, −90, and −100. In one embodiment, the crystallization temperature (° C.) of the component (B) is preferably −100 to 100. In the present disclosure, the crystallization temperature (° C.) is a value measured by a method described in JIS K 7121.

Examples of the upper limit of the content (in terms of solid contents, % by mass) of the component (b1) with respect to 100% by mass of the component (A) and the component (B) of the present disclosure in terms of solid contents include 99, 95, 90, 85, 80, 75, 70, 65, 60, 55, and 51, and examples of the lower limit thereof include 95, 90, 85, 80, 75, 70, 65, 60, 55, 51, and 50. In one embodiment, the content (in terms of solid contents, % by mass) of the component (b1) with respect to 100% by mass of the components (A) and the component (B) of the present disclosure in terms of solid contents is preferably about more than 50 and equal to or less than 99.

Examples of the upper limit of the content (% by mass, in terms of solid contents) of the component (B) with respect to 100% by mass of the component (A), the component (B), and the component (C) of the present disclosure in terms of solid contents include 99, 95, 90, 85, 80, 75, 70, 65, 60, and 55, and examples of the lower limit thereof include 95, 90, 85, 80, 75, 70, 65, 60, 55, and 50. In one embodiment, the content (% by mass, in terms of solid contents) of the component (B) with respect to 100% by mass of the component (A), the component (B), and the component (C) of the present disclosure in terms of solid contents is preferably about 50 to 99.

Component (C)

Various known polyvinyl alcohols can be used as a polyvinyl alcohol (C) in which the average saponification degree is 75 mol % or more and 85 mol % or less (also referred to as “component (C)” in the present disclosure). In the present disclosure, the average saponification degree is the average value of the saponification degree of the entire component (C).

Examples of the upper limit of the average degree of polymerization of the component (C) include 4,000, 3,500, 3,000, 2,500, 2,000, 1,500, 1,000, 500, 250, 200, and 150, and examples of the lower limit thereof include 3,500, 3,000, 2,500, 2,000, 1,500, 1,000, 500, 250, 200, 150, and 100. In one embodiment, the average degree of polymerization of the component (C) is preferably about 100 to 4,000. In the present disclosure, the average degree of polymerization of the polyvinyl alcohol is a value measured by a method described in JIS K 6726.

Examples of the upper limit of the average saponification degree (mol %) of the component (C) include 85, 84, 83, 82, 81, 80, 79, 78, 77, and 76, and examples of the lower limit thereof include 84, 83, 82, 81, 80, 79, 78, 77, 76, and 75. In one embodiment, the average saponification degree (mol %) of the component (C) is about 75 to 85. When the average saponification degree (mol %) exceeds 85, the heat sealability at low temperature is inferior, which is not preferable. In the present disclosure, the saponification degree (mol %) of the polyvinyl alcohol is a value measured by a method described in JIS K 6726.

Examples of the upper limit of the content (% by mass, in terms of solid contents) of the component (C) with respect to 100% by mass of the component (A), the component (B), and the component (C) of the present disclosure in terms of solid contents include 20, 15, 10, 9, 8, 7, 6, 5, 4, 3, 2, and 1, and examples of the lower limit thereof include 15, 10, 9, 8, 7, 6, 5, 4, 3, 2, 1, and 0.5. In one embodiment, the content of the component (C) (% by mass, in terms of solid contents) with respect to 100% by mass of the component (A), the component (B), and the component (C) of the present disclosure in terms of solid contents is preferable about 0.5 to 20.

Component (D)

Various known compounds can be used as one or more compounds (D) selected from the group consisting of monosaccharides, disaccharides, sugar alcohols, organic acids, amino acids, and ureas (also referred to as “component (D)” in the present disclosure). The component (D) does not include the component (A).

Examples of the monosaccharides include aldoses and ketoses. Examples of the aldoses include aldotrioses, aldotetroses, aldopentoses, and aldohexoses. Examples of the aldotrioses include glyceraldehyde. Examples of the aldotetroses include erythrose and threose. Examples of the aldopentoses include ribose, xylose, and arabinose. Examples of the aldohexoses include glucose, mannose, and galactose. Examples of the ketoses include ketotrioses, ketotetroses, ketopentoses, and ketohexoses. Examples of the ketotrioses include dihydroxyacetone. Examples of the ketotetroses include erythrose. Examples of the ketopentoses include xylulose and ribulose. Examples of the ketohexoses include fructose.

Examples of the disaccharides include sucrose, lactose, maltose, trehalose, and cellobiose.

Examples of the sugar alcohols include glycerin, erythritol, threitol, arabinitol, xylitol, ribitol, iditol, sorbitol, galactitol, mannitol, volemitol, perseitol, erythro-galacto-octitol, isomalt, lactitol, and maltitol.

Examples of the organic acids include formic acid, organic acids having a chain aliphatic structure (citric acid, malic acid, lactic acid, tartaric acid, acetic acid, glycolic acid, oxalic acid, malonic acid, succinic acid, fumaric acid, α-ketoglutaric acid, and the like), organic acids having an aromatic ring structure (salicylic acid, p-coumaric acid, caffeic acid, ferulic acid, chlorogenic acid), organic acids having an alicyclic ring structure (quinic acid and the like), and organic acids having a heterocyclic ring structure (orotic acid and the like). The chain aliphatic structure is an aliphatic structure not having a ring structure and having two or more carbon atoms. It is also conceivable to adjust the pH of the heat sealing aqueous resin composition of the present disclosure according to the type and the amount of the organic acid. The organic acid does not include the organic acid (resin acid) contained in rosin.

Examples of the amino acids include acidic amino acids, basic amino acids, and neutral amino acids. Examples of the acidic amino acids include aspartic acid and glutamic acid. Examples of the basic amino acids include lysine, arginine, and histidine. Examples of the neutral amino acids include neutral amino acids (glycine, alanine, valine, leucine, isoleucine, phenylalanine, proline, and the like) in which the side chain is hydrogen or a hydrocarbon group, and neutral amino acids (serine, tyrosine, tryptophan, threonine, cysteine, asparagine, glutamine) having a polar side chain (OH, NH, NH₂, SH, and the like). Examples of other amino acids include theanine and cystine. It is also conceivable to adjust the pH of the heat sealing aqueous resin composition of the present disclosure according to the type and the amount of the amino acid.

Examples of the ureas include urea, and N,N-dimethylurea.

Examples of the upper limit of the molecular weight of the component (D) include 500, 450, 400, 350, 300, 250, 200, 150, 100, 50, and 40, and examples of the lower limit thereof include 450, 400, 350, 300, 250, 200, 150, 100, 50, 40, and 30. In one embodiment, the molecular weight of the component (D) is preferably 500 or less, and more preferably 10 or more and 500 or less. In the present disclosure, when “molecular weight” is merely described, this refers to a value calculated on an atomic weight basis.

Examples of the upper limit of the content (% by mass, in terms of solid contents) of the component (D) with respect to 100% by mass of the component (A), the component (B), and the component (C) of the present disclosure in terms of solid contents include 20, 15, 10, 9, 8, 7, 6, 5, 4, 3, 2, and 1, and examples of the lower limit thereof include 15, 10, 9, 8, 7, 6, 5, 4, 3, 2, 1, and 0.5. In one embodiment, the content of the component (D) (% by mass, in terms of solid contents) with respect to 100% by mass of the component (A), the component (B), and the component (C) of the present disclosure in terms of solid contents is preferable about 0.5 to 20.

Heat Sealing Aqueous Resin Composition

As long as the desired characteristics are not impaired, the heat sealing aqueous resin composition of the present disclosure may contain a crosslinking agent, a defoamer, a thickener, a filler, an antioxidant, a water-resistant agent, a film forming aid, a pH adjuster, a solvent (a water-soluble organic solvent, a water-insoluble organic solvent), an emulsifier, a dispersant, a preservative, a printability improver, a viscosity adjuster, a pigment, a filler, an oil-resistant agent, a barrier agent, or a tackifier, as necessary. Examples of the water-soluble organic solvent include alcohols and ketones. Examples of the alcohols include methanol, ethanol, i-propanol, n-butanol, n-octanol, ethylene glycol monomethyl ether, ethylene glycol monoethyl ether, ethylene glycol mono-n-butyl ether, propylene glycol monomethyl ether, and propylene glycol monoethyl ether. Examples of the ketones include acetone and methyl ethyl ketone. Although the water-insoluble organic solvent may be contained in the heat sealing aqueous resin composition of the present disclosure, the heat sealing aqueous resin composition of the present disclosure can be obtained without incorporating it. Furthermore, in consideration of reducing the impact on the environment, the heat sealing aqueous resin composition of the present disclosure preferable does not contain the water-insoluble organic solvent. Examples of the water-insoluble organic solvent include toluene and xylene.

The heat sealing aqueous resin composition of the present disclosure preferably contains the dispersant because than the storage stability is favorable. Examples of the dispersant include cellulose nanofibers, carboxymethyl cellulose, starch, chitosan, alginic acid, polyvinylpyrrolidone, polyacrylic acid, and salts thereof. Among these, cellulose nanofibers, carboxymethyl cellulose, starch, chitosan, alginic acid, and salts thereof are preferable because they are naturally derived and biodegradable.

The heat sealing aqueous resin composition of the present disclosure is used in the form of an aqueous emulsion. Examples of methods of forming the composition containing the component (A), the component (B), and the component (C) of the present disclosure, and the component (D) and the other components which are used if necessary into the aqueous emulsion include an inversion emulsification method. Examples of the inversion emulsification method include a method of emulsifying by raising the temperature of the mixture of the component (A) and the component (B) to about 100° C. or higher and 200° C. or lower under normal pressure (performing pressurization of 1 MPa or less as necessary), thereafter kneading the component (C), and gradually adding hot water to cause phase-transfer emulsification. The component (D) may be mixed at the same time when making the mixture of the component (A) and the component (B), or before or after making it, or may be mixed at the same time when compounding the component (C), or before or after the compounding it. The appearance of the aqueous emulsion of the present disclosure thus obtained is white or milky white, or pale yellow. The inversion emulsification method of the present disclosure is preferably carried out under normal pressure. The state when kneading the component (C) may be a state in which the component (C) is dissolved in water, or may be a state in which the component (C) is not dissolved in water. Furthermore, the inversion emulsification method of the present disclosure can be carried out without a solvent. The phrase “without a solvent” in the inversion emulsification method of the present disclosure means that solvents other than a trace amount of the solvent derived from the raw material are not contained. Therefore, when a trace amount of the solvent derived from the raw material is contained, examples of the upper limit of the amount (% by mass) of the solvent contained in the heat sealing aqueous resin composition of the present disclosure with respect to 100% by mass of the heat sealing aqueous resin composition in terms of solid contents include 1, 0.5, 0.1, 0.05, 0.01, and 0.001, and examples of the lower limit thereof include 0.5, 0.1, 0.05, 0.01, 0.001, and 0.0001. In one embodiment, the amount (% by mass) of the solvent contained in the heat sealing aqueous resin composition of the present disclosure is 1 or less.

Examples of the upper limit of the concentration (% by mass) of the heat sealing aqueous resin composition of the present disclosure include 99, 95, 90, 85, 80, 75, 70, 65, 60, 55, 50, 45, 40, 35, 30, 25, 20, 15, 10, and 5, and examples of the lower limit thereof include 95, 90, 85, 80, 75, 70, 65, 60, 55, 50, 45, 40, 35, 30, 25, 20, 15, 10, 5, and 1. In one embodiment, the concentration (% by mass) of the heat sealing aqueous resin composition of the present disclosure is preferably about 1% to 99% by mass, and more preferably 1% to 60% by mass.

Examples of the upper limit of the volume average particle size (μm) of the heat sealing aqueous resin composition of the present disclosure include 10, 8, 6, 4, 2, 1.5, 1, 0.7, 0.5, 0.3, 0.1, and 0.05, and examples of the lower limit thereof include 8, 6, 4, 2, 1.5, 1, 0.7, 0.5, 0.3, 0.1, 0.05, and 0.01. In one embodiment, the volume average particle size (μm) of the heat sealing aqueous resin composition of the present disclosure is preferably about 0.01 to 10 μm. Most parts of the heat sealing aqueous resin composition of the present disclosure are uniformly dispersed as particles of 2 μm or less, but the volume average particle size thereof is preferably 1.5 μm or less from the viewpoint the storage stability.

Examples of the upper limit of the viscosity (mPa·s) of the heat sealing aqueous resin composition of the present disclosure at the temperature of 25° C. and the concentration of 40% by mass include 1,000, 750, 500, 250, 100, 75, 50, and 25, and examples of the lower limit thereof include 750, 500, 250, 100, 75, 50, 25, and 10. In one embodiment, the viscosity (mPa·s) of the heat sealing aqueous resin composition of the present disclosure at the temperature of 25° C. and the concentration of 40% by mass is preferably about 10 to 1,000.

Examples of the upper limit of the pH of the heat sealing aqueous resin composition of the present disclosure include 10, 9, 8, 7, 6, 5, 4, and 3, and examples of the lower limit thereof include 9, 8, 7, 6, 5, 4, 3, and 2. In one embodiment, the pH of the heat sealing aqueous resin composition of the present disclosure is preferably about 2 to 10. The pH of the heat sealing aqueous resin composition of the present disclosure may be adjusted by appropriately adding inorganic acids (hydrochloric acid, sulfuric acid, phosphoric acid, and the like), alkanolamines (monoethanolamine, diethanolamine, diisopropanolamine, and the like), aliphatic amines (ethylamine, n-butylamine, triethylamine, and the like), alkali metal hydroxides (potassium hydroxide, sodium hydroxide, and the like), alkaline earth metal hydroxides (calcium hydroxide and the like), or the like, as necessary.

A film of the heat sealing aqueous resin composition of the present disclosure can adhere two substrates. Examples of methods of adhering the two substrates using the heat sealing aqueous resin composition of the present disclosure include the following methods:

(1) A method in which the heat sealing aqueous resin composition of the present disclosure is applied to each of the two substrates such that the solid adhesion amount after drying is 2 to 10 g/cm², the application surfaces of the substrates are superimposed on each other, and the pressure of about 0.5 to 5 kgf/cm² is applied while applying heat of 80° C. to 180° C. with a heat seal machine (for example, a heat seal tester TP-701S (manufactured by TESTER SANGYO CO., LTD.), and the like);

(2) A method in which the heat sealing aqueous resin composition of the present disclosure is applied to one of the substrates such that the solid adhesion amount after drying is 2 to 20 g/cm², and while applying heat of 80° C. to 180° C., the other substrate is superimposed thereon to apply the pressure of about 0.5 to 5 kgf/cm²; and

(3) A method in which the heat sealing aqueous resin composition of the present disclosure is previously applied to the substrate that is likely to be peeled off such that the solid adhesion amount after drying is 4 to 20 g/cm², water is volatilized by applying heat of 80° C. to 180° C. to form a film of the heat sealing aqueous resin composition, the obtained film is acquired by peeling it off from the substrate that is likely to be peeled off, and this film is disposed between the two substrates to apply the pressure of 0.5 to 5 kgf/cm² at 80° C. to 180° C.

The film of the heat sealing aqueous resin composition may be provided not only on one side of the substrate but also on both sides thereof.

Examples of the substrates to be coated with the heat sealing aqueous resin composition of the present disclosure include glass substrates, plastic substrates, paper substrates, cloth substrates, rubber sheet substrates, foam sheet substrates, and metal substrates. Examples of the plastic substrates include thermoplastic plastic substrates and thermosetting plastic substrates. Examples of the thermoplastic plastic substrates include general-purpose plastic substrates and engineering plastic substrates. Examples of the general-purpose plastic substrates include olefin-based, polyester-based, acrylic-based, vinyl-based, and polystyrene-based substrates. Examples of the olefin-based substrates include polyethylene, polypropylene, and norbornene substrates. Examples of the polyester-based substrates include polyethylene terephthalate (PET), polyethylene naphthalate (PEN), polybutylene succinate (PBS), polybutylene succinate adipate (PBSA), polybutylene adipate terephthalate (PBAT), polylactic acid (PLA), polyhydroxyalkanoate (PHA), and polycaprolactone (PCL) substrates. Examples of the acrylic-based substrates include polymethyl methacrylate (PMMA) substrates. Examples of the vinyl-based substrates include polyvinyl chloride, polyvinylidene chloride, and polyvinyl alcohol substrates. Examples of the polystyrene-based substrates include polystyrene (PS) resin, styrene-acrylonitrile (AS) resin, and styrene-butadiene-acrylonitrile (ABS) resin substrates. Examples of the engineering plastic substrates include general-purpose engineering plastic and super engineering plastic substrates. Examples of the general-purpose engineering plastic include polycarbonate and polyamide (nylon). Examples of the super engineering plastic include polyether ether ketone (PEEK). Examples of the thermosetting plastic substrates include polyimide, epoxy resin, and melamine resin substrates. Examples of other plastic substrates include triacetyl cellulose resin, cellophane, and plasticized starch substrates. Examples of the paper substrates include Japanese paper, kraft paper, glassine paper, high-quality paper, synthetic paper, and top-coated paper. Examples of the cloth substrates include woven fabrics and non-woven fabrics made by various fibrous substances alone or by blending them. Examples of the rubber sheet substrates include natural rubber and butyl rubber sheet substrates. Examples of the foam sheet substrates include polyurethane foam and polychloroprene foam rubber sheet substrates. Examples of the metal substrates include aluminum foil and copper foil substrates. Furthermore, the substrate may be a substrate that has been surface-treated (corona discharge or the like). Furthermore, another layer or film (such as an easy adhesion layer and an anchor layer) may be provided between one surface or both surfaces of the substrate and the film of the heat sealing aqueous resin composition of the present disclosure. The substrate is preferably a paper substrate and more preferably kraft paper because they are biomass materials and are excellent in biodegradability. The thickness of the substrate is not particularly limited, but generally, about 30 to 300 μm is sufficient.

Examples of methods of coating the substrate with the heat sealing aqueous resin composition of the present disclosure include roll coater coating, reverse roll coater coating, bar coater coating, Mayer bar coating, air knife coating, gravure coating, reverse gravure coating, offset printing, flexographic printing, and screen printing. The amount of coating is not particularly limited, but it is usually in the range of 2 to 20 g/m² after drying, preferably 4 to 10 g/m², and more preferably 5 to 8 g/m². Furthermore, the thickness of the film of the heat sealing aqueous resin composition of the present disclosure is about 2 to 20 μm. When the substrate is aqueous-coated with the heat sealing aqueous resin composition provided in the present disclosure, the use amount of the heat sealing aqueous resin composition can be reduced. Conventionally, there have been problems such as hindrance of the recyclability of paper when laminating a heat sealing resin composition using paper or the like as a substrate for example, but in the present disclosure, by reducing the use amount of the heat sealing aqueous resin composition, a favorable effect in which the recyclability of the paper is not hindered can be shown.

The heat sealing aqueous resin composition of the present disclosure is preferably used as a heat sealing agent, but it can also be used in various usages that can exhibit the effect shown by the heat sealing aqueous resin composition of the present disclosure.

### EXAMPLES

Specific examples of the present disclosure will be described below with reference to examples, but the present disclosure is not limited to these examples. In the examples, parts and % are all based on solid content mass unless otherwise specified.

### Production Example 1: Production of Hydrogenated Rosin Glycerol Ester

500 g of hydrogenated rosin (product name “PINECRYSTAL KR-85,” manufactured by Arakawa Chemical Industries, Ltd.) was put in a 1-liter flask, the temperature was raised to 180° C. under nitrogen sealing, 60 g of glycerin was added at 200° C. under melt-stirring, the temperature was raised to 280° C. thereafter, and an esterification reaction was carried out at the same temperature for 12 hours to obtain 515 g of hydrogenated rosin glycerol ester.

### Production Example 2: Production of Rosin Glycerol Ester

500 g of gum rosin derived from Chinese horsetail pine (manufactured by Guangxi Wuzhou Arakawa Chemical Industries, Ltd.) was put in a 1-liter flask, the temperature was raised to 180° C. under nitrogen sealing, 60 g of glycerin was added at 200° C. under melt-stirring, the temperature was raised to 280° C. thereafter, and an esterification reaction was carried out at the same temperature for 12 hours to obtain 515 g of rosin glycerol ester.

### Production Example 3: Production of Disproportionated Rosin Ester

0.3 g of 5% palladium on carbon as a catalyst was added to 1000 g of gum rosin derived from Chinese horsetail pine (manufactured by Guangxi Wuzhou Arakawa Chemical Industries, Ltd.), stirring was performed at 280° C. for 4 hours under nitrogen sealing, and a disproportionation reaction was carried out to obtain disproportionated rosin. 500 g of the obtained disproportionated rosin was put in a 1-liter flask, the temperature was raised to 180° C. under nitrogen sealing, 43 g of glycerin and 33 g of diethylene glycol were added at 200° C. under melt-stirring, the temperature was raised to 270° C. thereafter, and an esterification reaction was carried out at the same temperature for 12 hours to obtain 517 g of disproportionated rosin ester.

### Example 1: Preparation of Heat Sealing Aqueous Resin Composition (1)

A mixture of 10 parts of hydrogenated rosin (product name “PINECRYSTAL KR-85,” manufactured by Arakawa Chemical Industries, Ltd.) and 90 parts of polybutylene succinate adipate (product name “BioPBS FD92,” manufactured by PTT MCC Biochem Co., Ltd.) (also referred to as “PBSA” in the present disclosure) was put in a reaction container equipped with a dropping funnel, a thermometer, a nitrogen introduction tube, a stirrer, and a cooling tube, the temperature was raised to 160° C., and while stirring, an aqueous solution in which 5 parts of polyvinyl alcohol (product name “KURARAY POVAL 32-80,” manufactured by Kuraray Co., Ltd.) was dissolved in 45 parts of water was added dropwise over 50 minutes. While heating and stirring, 112.5 parts of distilled water heated to 80° C. was added dropwise over 1 hour to prepare a heat sealing aqueous resin composition (1) (oil-in-water-type emulsion) having the solid content of 40% by mass.

### Examples 2 to 17 and Comparative Examples 1 to 8: Preparation of Heat Sealing Aqueous Resin Compositions (2) to (17) and (C1) to (C8)

Heat sealing aqueous resin compositions (2) to (17) and (C1) to (C8) were obtained by carrying out Examples 2 to 17 and Comparative Examples 1 to 8 in the same manner as in Example 1 except that the compositions shown in Table 1 to Table 3 were changed. A treatment method when adding the component (D) was carried out in the same manner as in Example 1 except that the component (D) was added after the process of dropwise addition of the polyvinyl alcohol aqueous solution of Example 1.

### Evaluation Example 1: Production of Laminate (1)

Such that the solid adhesion amount after drying was 6 g/m², the heat sealing aqueous resin composition was applied to kraft paper (product name “HEIKO,” manufactured by SHIMOJIMA Co., Ltd., basis weight: 70 g/m²) using a Mayer bar, and dried at 120° C. for 3 minutes to form a film of the heat sealing aqueous resin composition, thereby obtaining a laminate (1).

### Evaluation Examples 2 to 17 and Comparative Evaluation Examples 1 to 8: Production of Laminates (2) to (17) and (C1) to (C8)

Laminates (2) to (17) and (C1) to (C8) were obtained by carrying out Evaluation Examples 2 to 17 and Comparative Evaluation Examples 1 to 8 in the same manner as in Evaluation Example 1 except that the heat sealing aqueous resin composition (1) was changed to each of the heat sealing aqueous resin compositions (2) to (17) or (C1) to (C8).

Performance Evaluation (1): Appearance Observation

The degree of dispersion of the heat sealing aqueous resin composition in water was evaluated according to the following criteria.

O: favorably dispersed.

X: not dispersed.

Performance Evaluation (2): Heat Seal Strength (N/15 mm)

Each of the laminates was cut into 75 mm×110 mm to fold the coated surface inward in half vertically. The folded side was thermocompression bonded (110° C., 1 second, 2 kgf/cm²) using a heat seal tester TP-701S (manufactured by TESTER SANGYO CO., LTD.) with the seal width of 20 mm from the end. This was divided into five equal pieces to produce five test pieces of 15 mm×55 mm. In each of the test pieces, 180° was opened with the seal portion in the center, and using a TENSILON universal tester RTG-1210 (manufactured by A&D Company, Limited), each was pulled in a vertical direction with the gripper spacing: 30 mm and at the peeling rate: 300 mm/min to measure the value of the maximum load. The average value of the five test pieces was taken as the value of the heat seal strength.

TABLE 1

| | | Examples | | | | | | | | | |
|---|---|---|---|---|---|---|---|---|---|---|---|
| | | 1 | 2 | 3 | 4 | 5 | 6 | 7 | 8 | 9 | 10 |
| (A) | Hydrogenated rosin | 10 | | 10 | | | | 20 | 10 | 10 | 10 |
| | Hydrogenated rosin glycerol ester | | 10 | 10 | | | | 20 | | | |
| | Rosin | | | | 10 | | | | | | |
| | Rosin glycerol ester | | | | | 10 | | | | | |
| | Disproportionated rosin ester | | | | | | 10 | | | | |
| (A)′ | Paraffin wax | | | | | | | | | | |
| | Acetyl sucrose | | | | | | | | | | |
| | Hydrogenated petroleum resin | | | | | | | | | | |
| (B) | PBSA | 90 | 90 | 80 | 90 | 90 | 90 | 60 | 60 | | 90 |
| | PCL | | | | | | | | 30 | 90 | |
| | PLA | | | | | | | | | | |
| (C) | PVA-1 | | | | | | | | | | |
| | PVA-2 | 5 | 5 | 5 | 5 | 5 | 5 | 5 | 5 | 5 | |
| | PVA-3 | | | | | | | | | | 5 |
| | PVA-4 | | | | | | | | | | |
| (D) | Glycerin | | | | | | | | | | |
| | Sucrose | | | | | | | | | | |
| | Urea | | | | | | | | | | |
| | Glucose | | | | | | | | | | |
| | Acetic acid | | | | | | | | | | |
| | Aspartic acid | | | | | | | | | | |

| | | | | | | | | | | |
|---|---|---|---|---|---|---|---|---|---|---|
| Average saponification degree (mol %) of PVA | 80 | 80 | 80 | 80 | 80 | 80 | 80 | 80 | 80 | 82 |
| Appearance observation | O | O | O | O | O | O | O | O | O | O |
| Heat seal strength (N/15 mm) | 3.5 | 3.8 | 4.0 | 3.2 | 3.5 | 3.9 | 3.0 | 3.8 | 3.7 | 3.3 |

TABLE 2

| | | Examples | | | | | | | | | |
|---|---|---|---|---|---|---|---|---|---|---|---|
| | | 11 | 12 | 13 | 14 | 15 | 16 | 17 | 18 | 19 | 20 |
| (A) | Hydrogenated rosin | 10 | 10 | 10 | 10 | 10 | 10 | 10 | 10 | 10 | 10 |
| | Hydrogenated rosin glycerol ester | | | | | | | | | | |
| | Rosin | | | | | | | | | | |
| | Rosin glycerol ester | | | | | | | | | | |
| | Disproportionated rosin ester | | | | | | | | | | |
| (A)′ | Paraffin wax | | | | | | | | | | |
| | Acetyl sucrose | | | | | | | | | | |
| | Hydrogenated petroleum resin | | | | | | | | | | |
| (B) | PBSA | 90 | 90 | 90 | 90 | 90 | 90 | 90 | 90 | 90 | 90 |
| | PCL | | | | | | | | | | |
| | PLA | | | | | | | | | | |
| (C) | PVA-1 | 1 | 2.5 | 2.5 | | | | | | | |
| | PVA-2 | 4 | 2.5 | 2.5 | | 5 | 5 | 5 | 5 | 5 | 5 |
| | PVA-3 | | | | 2.5 | | | | | | |
| | PVA-4 | | | | 2.5 | | | | | | |
| (D) | Glycerin | | | 5 | | 5 | | | | | |
| | Sucrose | | | | | | 5 | | | | |
| | Urea | | | | | | | 5 | | | |
| | Glucose | | | | | | | | 5 | | |
| | Acetic acid | | | | | | | | | 5 | |
| | Aspartic acid | | | | | | | | | | 5 |

| | | | | | | | | | | |
|---|---|---|---|---|---|---|---|---|---|---|
| Average saponification degree (mol %) of PVA | 82 | 84 | 84 | 76 | 80 | 80 | 80 | 80 | 80 | 80 |
| Appearance observation | O | O | O | O | O | O | O | O | O | O |
| Heat seal strength (N/15 mm) | 3.2 | 2.5 | 3.0 | 3.7 | 4.1 | 4.2 | 4.0 | 4.0 | 3.9 | 3.9 |

TABLE 3

| | | Comparative Examples | | | | | | | |
|---|---|---|---|---|---|---|---|---|---|
| | | 1 | 2 | 3 | 4 | 5 | 6 | 7 | 8 |
| (A) | Hydrogenated rosin | 10 | 10 | 25 | | | | 10 | 10 |
| | Hydrogenated rosin glycerol ester | | | 25 | | | | | |
| | Rosin | | | | | | | | |
| | Rosin glycerol ester | | | | | | | | |
| | Disproportionated rosin ester | | | | | | | | |
| (A)′ | Paraffin wax | | | | 10 | | | | |
| | Acetyl sucrose | | | | | 10 | | | |
| | Hydrogenated petroleum resin | | | | | | 10 | | |
| (B) | PBSA | 90 | 90 | 50 | 90 | 90 | 90 | | 90 |
| | PCL | | | | | | | | |
| | PLA | | | | | | | 90 | |
| (C) | PVA-1 | 5 | 5 | | | | | | |
| | PVA-2 | | | 5 | 5 | 5 | 5 | 5 | |
| | PVA-3 | | | | | | | | |
| | PVA-4 | | | | | | | | 5 |
| (D) | Glycerin | | 5 | | | | | | |
| | Sucrose | | | | | | | | |
| | Urea | | | | | | | | |
| | Glucose | | | | | | | | |
| | Acetic acid | | | | | | | | |
| | Aspartic acid | | | | | | | | |

| | | | | | | | | |
|---|---|---|---|---|---|---|---|---|
| Average saponification degree (mol %) of PVA | 88 | 88 | 80 | 80 | 80 | 80 | 80 | 71 |
| Appearance observation | O | O | O | X | X | X | X | X |
| Heat seal strength (N/15 mm) | 0.5 | 1.0 | 1.5 | — | — | — | — | — |

The meanings of the terms in Table 1 to Table 3 are as follows. The numerical values of each component in the tables indicate the mass of the solid content.

Hydrogenated rosin: product name “PINECRYSTAL KR-85” (manufactured by Arakawa Chemical Industries, Ltd., softening point: 80° C. to 90° C.)

Hydrogenated rosin glycerol ester: Production Example 1 (softening point: 95° C. to 105° C.)

Rosin: “gum rosin derived from Chinese horsetail pine” (manufactured by Guangxi Wuzhou Arakawa Chemical Industries, Ltd., softening point: 80° C. to 90° C.)

Rosin glycerol ester: Production Example 2 (softening point: 95° C. to 105° C.)

Disproportionated rosin ester: Production Example 3 (softening point: 70° C. to 80° C.)

Paraffin wax: product name “Paraffin Wax-135” (manufactured by NIPPON SEIRO CO., LTD., melting point: 55° C. to 60° C.)

Acetyl sucrose: product name “MONOPET SOA” (manufactured by DKS Co., Ltd., melting point: 78° C. to 90° C.)

Hydrogenated petroleum resin: product name “Arkon P-90” (manufactured by Arakawa Chemical Industries, Ltd., softening point: 85° C. to 95° C.)

PBSA: polybutylene succinate adipate (product name “BioPBS FD92,” manufactured by PTT MCC Biochem Co., Ltd.)

PCL: polycaprolactone (product name “CAPA 6800D” (manufactured by Ingevity Corporation), melting point: 58° C. to 60° C.)

PLA: polylactic acid (product name “TERRAMAC TP-4000” (manufactured by UNITIKA LTD.), melting point: 170° C.)

PVA-1: product name “KURARAY POVAL 30-88” (manufactured by Kuraray Co., Ltd., saponification degree: 87.0 to 89.0, viscosity (4%, 20° C., mPa·s): 27.0 to 33.0)

PVA-2: product name “KURARAY POVAL 32-80” (manufactured by Kuraray Co., Ltd., saponification degree: 79.0 to 81.0, viscosity (4%, 20° C., mPa·s): 29.0 to 35.0)

PVA-3: product name “KURARAY POVAL 5-82” (manufactured by Kuraray Co., Ltd., saponification degree: 80.0 to 83.0, viscosity (4%, 20° C., mPa·s): 4.5 to 5.2)

PVA-4: product name “KURARAY POVAL L-8” (manufactured by Kuraray Co., Ltd., saponification degree: 69.5 to 72.5, viscosity (4%, 20° C., mPa·s): 5.0 to 5.8)

Glycerin: product name “Glycerin special grade” (manufactured by KISHIDA CHEMICAL CO., LTD.)

Sucrose: product name “Sucrose special grade” (manufactured by KISHIDA CHEMICAL CO., LTD.)

Urea: product name “Urea for biochemistry” (manufactured by KISHIDA CHEMICAL CO., LTD.)

Glucose: product name “D-(+)-glucose special grade” (manufactured by KISHIDA CHEMICAL CO., LTD.)

Acetic acid: product name “Acetic acid special grade” (manufactured by KISHIDA CHEMICAL CO., LTD.)

Aspartic acid: product name “L-aspartic acid special grade” (manufactured by KISHIDA CHEMICAL CO., LTD.)

Method of measuring the saponification degree (mol %): in accordance with a polyvinyl alcohol test method in JIS K 6726-1994.

What is claimed is:

1. A heat sealing aqueous resin composition comprising:
a rosin resin (A);
a biodegradable resin (B) including a resin having a structure of General Formula (1) and/or a resin (b1) having a structure of General Formula (2); and
a polyvinyl alcohol (C) in which an average saponification degree is 75 mol % or more and 85 mol % or less,
wherein a content of the component (b1) is more than 50% by mass when a total content of the component (A) and the component (B) is 100% by mass,
—O—(CH₂)ₓ—O—CO—(CH₂)_{y}—CO— General Formula (1):
in General Formula (1), x and y may be different from each other, and are integers of 1 or more and 10 or less, and
—O—(CH₂)_{z}—CO— General Formula (2):
in General Formula (2), z is an integer of 3 or more and 10 or less.

2. The heat sealing aqueous resin composition according to claim 1, further comprising one or more compounds (D) selected from the group consisting of monosaccharides, disaccharides, sugar alcohols, organic acids, amino acids, and ureas.

3. A film of the heat sealing aqueous resin composition according to claim 1.

4. A film of the heat sealing aqueous resin composition according to claim 2.

5. A laminate comprising:
the film according to claim 3; and
a substrate.

6. A laminate comprising:
the film according to claim 4; and
a substrate.

7. A method for producing a heat sealing aqueous resin composition, comprising:
inversion-emulsifying a mixture of a component (A) and a component (B) without a solvent and under a normal pressure or a pressure of 1 MPa or less.
